(19) United States
(12) Patent Application Publication
(10) Pub. No.: US 2026/0135148 A1
(43) Pub. Date: May 14, 2026

(54) Potassium-Ion Battery Electrolytic Solution Additive, Potassium-Ion Battery Electrolytic Solution, Potassium-Ion Battery, Potassium-Ion Capacitor Electrolytic Solution Additive, Potassium-Ion Capacitor Electrolytic Solution, Potassium-Ion Capacitor, and Negative Electrode

(71) Applicant: Tokyo University of Science Foundation, Tokyo (JP)

(72) Inventors: Shinichi Komaba, Tokyo (JP); Kei Kubota, Tokyo (JP); Ryoichi Tatara, Tokyo (JP); Tomooki Hosaka, Tokyo (JP); Tatsuo Matsuyama, Tokyo (JP)

(21) Appl. No.: 18/703,782

(22) PCT Filed: Oct. 21, 2022
(86) PCT No.: PCT/JP2022/039411

§ 371 Date: Apr. 23, 2024

(30) Foreign Application Priority Data
Oct. 25, 2021 (JP) 2021-173969

(51) Int. Cl. H01M 10/0567; H01G 11/60; H01G 11/64; H01M 4/02; H01M 4/40; H01M 4/583; H01M 10/054; H01M 10/0569

(52) U.S. Cl. CPC H01M 10/0567; H01G 11/60; H01G 11/64; H01M 4/40; H01M 4/583; H01M 10/054; H01M 10/0569; H01M 2004/027

(57) ABSTRACT

Provided is a potassium-ion battery or capacitor electrolytic solution additive, which is a compound represented by Formula (1), Formula (1A), or Formula (1B). In Formula (1), Formula (1A), and Formula (1B), R each independently represents NR¹R², an alkyl group, a cycloalkyl group, a heterocyclic group, an aryl group, or a heteroaryl group, each of R¹ and R² independently represents a hydrogen atom, an alkyl group, an aryl group, or, a heteroaryl group, and R¹ and R² may be bonded to form a ring structure. Provided that, in R bonded to a sulfur atom, in a case in which R is a heterocyclic group, the sulfur atom is bonded to an atom other than a nitrogen atom.

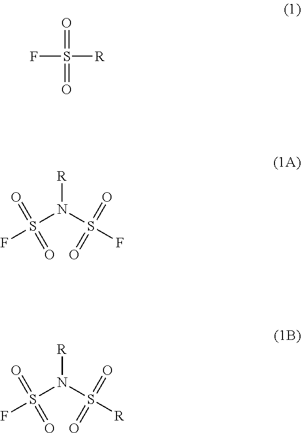

### TECHNICAL FIELD

The present invention relates to a potassium-ion battery electrolytic solution additive, a potassium-ion battery electrolytic solution, a potassium-ion battery, a potassium-ion capacitor electrolytic solution additive, a potassium-ion capacitor electrolytic solution, a potassium-ion capacitor, and a negative electrode.

### BACKGROUND ART

At present, as a high energy density secondary battery, a non-aqueous electrolyte secondary battery is widely used, for example, in which a non-aqueous electrolyte is used and lithium ions are transferred between a positive electrode and a negative electrode to perform charging and discharging.

As a secondary battery that can be charged and discharged, a lithium-ion secondary battery capable of achieving high energy density at a high voltage has been mainly used so far, but the amount of lithium resources is relatively limited, and lithium is expensive. Lithium resources are localized in South America, and Japan relies entirely on imports from overseas. Under such circumstances, a sodium-ion secondary battery replacing a lithium-ion secondary battery is currently under development for cost reduction and stable supply of batteries. However, sodium has a larger atomic weight than lithium, a standard electrode potential of about 0.33 V higher than lithium, and a low cell voltage, and thus, there is a problem in that it is difficult to achieve high energy density.

As a sulfamic acid derivative used in a lithium-ion battery, a sulfamic acid derivative described in Japanese National-Phase Publication (JP-A) No. 2020-500159 is known.

As a solvent used in a lithium-ion battery, a solvent described in W. Xue, J. Li, et al., Energy Environ. Sci., 13, 212 (2020) is known.

Recently, research on non-aqueous electrolyte secondary batteries using potassium ion instead of lithium ion and sodium ion has been started.

As a potassium-ion battery electrolytic solution or a potassium-ion capacitor electrolytic solution, those described in Japanese Patent Application Laid-Open (JP-A) No.

### SUMMARY OF INVENTION

### Technical Problem

An embodiment according to the present disclosure provides a potassium-ion battery electrolytic solution additive from which a potassium-ion battery excellent in coulombic efficiency can be obtained, a potassium-ion battery electrolytic solution containing the potassium-ion battery electrolytic solution additive, and a potassium-ion battery including the potassium-ion battery electrolytic solution.

Another embodiment according to the disclosure provides a potassium-ion capacitor electrolytic solution additive from which a potassium-ion capacitor excellent in coulombic efficiency can be obtained, a potassium-ion capacitor electrolytic solution containing the potassium-ion capacitor electrolytic solution additive, and a potassium-ion capacitor including the potassium-ion capacitor electrolytic solution.

Still another embodiment according to the disclosure provides a negative electrode using the potassium-ion battery electrolytic solution additive or the potassium-ion capacitor electrolytic solution additive.

### Solution to Problem

Means for solving the above problems include the following aspects.

<1> A potassium-ion battery electrolytic solution additive, which is a compound represented by the following Formula (1):

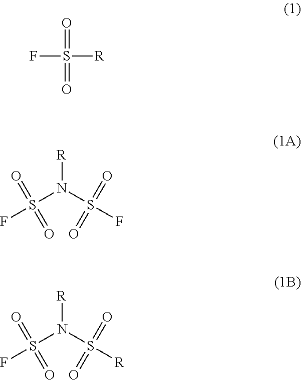

wherein R each independently represents NR¹R², an alkyl group, a cycloalkyl group, a heterocyclic group, an aryl group, or a heteroaryl group, each of R¹ and R² independently represents a hydrogen atom, an alkyl group, an aryl group, or, a heteroaryl group, and R¹ and R² may be bonded to form a ring structure, provided that, in R bonded to a sulfur atom, in a case in which R is a heterocyclic group, the sulfur atom is bonded to an atom other than a nitrogen atom.

<2> The potassium-ion battery electrolytic solution additive according to <1>, wherein the compound represented by the Formula (1) is a compound represented by the following Formula (2):

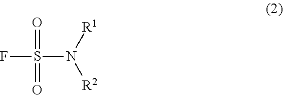

wherein each of R¹ and R² independently represents a hydrogen atom, an alkyl group, an aryl group, or, a heteroaryl group, and R¹ and R² may be bonded to form a ring structure.

<3> The potassium-ion battery electrolytic solution additive according to <2>, wherein each of R¹ and R² independently represents an alkyl group.

<4> The potassium-ion battery electrolytic solution additive according to any one of <1> to <3>, wherein a reductive decomposition potential is 0.5 V vs K/K+ or more.

<5> A potassium-ion battery electrolytic solution containing the potassium-ion battery electrolytic solution additive according to any one of <1> to <4>.

<6> The potassium-ion battery electrolytic solution according to <5>, wherein a content of the potassium-ion battery electrolytic solution additive is from 1% by mass to less than 40% by mass with respect to the total mass of the potassium-ion battery electrolytic solution.

<7> The potassium-ion battery electrolytic solution according to <5> or <6>, further containing a solvent.

<8> The potassium-ion battery electrolytic solution according to <7>, wherein the solvent includes at least one solvent selected from the group consisting of a carbonic ester compound and an ether compound.

<9> A potassium-ion battery including the potassium-ion battery electrolytic solution according to any one of <5> to <8>.

<10> A potassium-ion capacitor electrolytic solution additive, which is a compound represented by the following Formula (1), Formula (1A), or Formula (1B):

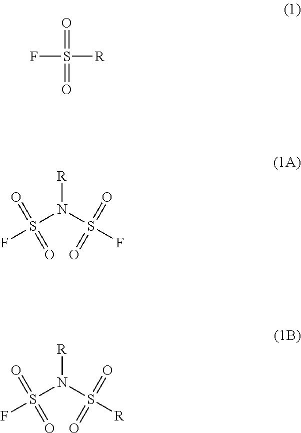

wherein R each independently represents NR¹R², an alkyl group, a cycloalkyl group, a heterocyclic group, an aryl group, or a heteroaryl group, each of R¹ and R² independently represents a hydrogen atom, an alkyl group, an aryl group, or, a heteroaryl group, and R¹ and R² may be bonded to form a ring structure, provided that, in R bonded to a sulfur atom, in a case in which R is a heterocyclic group, the sulfur atom is bonded to an atom other than a nitrogen atom.

<11> The potassium-ion capacitor electrolytic solution additive according to <9>, wherein the compound represented by the Formula (1) is a compound represented by the following Formula (2):

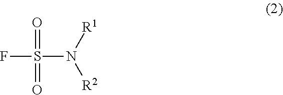

wherein each of R¹ and R² independently represents a hydrogen atom, an alkyl group, an aryl group, or, a heteroaryl group, and R¹ and R² may be bonded to form a ring structure.

<12> The potassium-ion capacitor electrolytic solution additive according to <10>, wherein each of R¹ and R² independently represents an alkyl group.

<13> The potassium-ion battery electrolytic solution additive according to any one of <10> to <12>, wherein a reductive decomposition potential is 0.5 V vs K/K+ or more.

<14> A potassium-ion capacitor electrolytic solution containing the potassium-ion capacitor electrolytic solution additive according to any one of <10> to <13>.

<15> The potassium-ion capacitor electrolytic solution according to <12>, wherein a content of the potassium-ion capacitor electrolytic solution additive is from 1% by mass to less than 40% by mass with respect to the total mass of the potassium-ion capacitor electrolytic solution.

<16> The potassium-ion capacitor electrolytic solution according to <12> or <13>, further containing a solvent.

<17> The potassium-ion capacitor electrolytic solution according to <14>, wherein the solvent includes at least one solvent selected from the group consisting of a carbonic ester compound and an ether compound.

<18> A potassium-ion capacitor including the potassium-ion capacitor electrolytic solution according to any one of <12> to <15>.

<19> A negative electrode including, on a surface thereof, a coating film containing a reductive decomposition product of the potassium-ion battery electrolytic solution additive according to any one of <1> to <4>.

<20> A negative electrode including, on a surface thereof, a coating film containing a reductive decomposition product of the potassium-ion capacitor electrolytic solution additive according to any one of <10> to <13>.

<21> The negative electrode according to <19>, wherein the coating film contains an S element and an F element.

<22> The negative electrode according to <19>, wherein the coating film contains SO₂, PF, and KF.

<23> The negative electrode according to <20>, wherein the coating film contains an S element and an F element.

<24> The negative electrode according to <20>, wherein the coating film contains SO₂, PF, and KF.

### Advantageous Effects of Invention

According to an embodiment according to the disclosure, it is possible to provide a potassium-ion battery electrolytic solution additive from which a potassium-ion battery excellent in coulombic efficiency can be obtained, a potassium-ion battery electrolytic solution containing the potassium-ion battery electrolytic solution additive, and a potassium-ion battery including the potassium-ion battery electrolytic solution.

According to another embodiment according to the disclosure, it is possible to provide a potassium-ion capacitor electrolytic solution additive from which a potassium-ion capacitor excellent in coulombic efficiency can be obtained, a potassium-ion capacitor electrolytic solution containing the potassium-ion capacitor electrolytic solution additive, and a potassium-ion capacitor including the potassium-ion capacitor electrolytic solution.

According to still another embodiment according to the disclosure, it is possible to provide a negative electrode using the potassium-ion battery electrolytic solution additive or the potassium-ion capacitor electrolytic solution additive.

### BRIEF DESCRIPTION OF DRAWINGS

FIG. 1 is a schematic view illustrating an example of a potassium-ion battery 10 according to the disclosure.

FIG. 2 shows a charge-discharge curve up to 20th cycle in Example 1.

FIG. 3 shows a charge-discharge curve up to 20th cycle in Comparative Example 1.

FIG. 4 shows a view of a change in discharge capacity in Example 1 and Comparative Example 1.

FIG. 5 shows a view of a change in coulombic efficiency in Example 1 and Comparative Example 1.

FIG. 6 shows a charge-discharge curve up to 20th cycle in Example 2.

FIG. 7 shows a view of a change in discharge capacity in Example 2 and Comparative Example 2.

FIG. 8 shows a view of a change in coulombic efficiency in Example 2 and Comparative Example 2.

FIG. 9 shows cyclic voltammetry (CV) curves in the case of using electrolytic solutions of Examples 3 to 6.

FIG. 10 shows surface analysis results of a negative electrode in Example 1 and Comparative Example 1.

FIG. 11 shows surface analysis results of a negative electrode in Example 1.

### DESCRIPTION OF EMBODIMENTS

Hereinafter, contents of the invention will be described in detail. While the description of the constituents described below will occasionally be made based on representative embodiments of the invention, the invention is not limited to such embodiments. In the present specification, “to” is used to mean that numerical values which are described before and after “to” are included as a lower limit value and an upper limit value, respectively.

In the disclosure, “mass %” and “wt %” are synonymous, and “part(s) by mass” and “part(s) by weight” are synonymous.

In the disclosure, a combination of two or more preferred aspects is a more preferred aspect.

(Potassium-Ion Battery Electrolytic Solution Additive and Potassium-Ion Capacitor Electrolytic Solution Additive)

A potassium-ion battery or potassium-ion capacitor electrolytic solution additive according to the disclosure (hereinafter, also referred to as “additive according to the disclosure”) is a compound represented by the following Formula (1), Formula (1A), or Formula (1B):

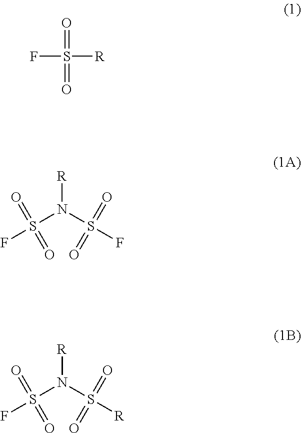

In Formula (1), Formula (1A), and Formula (1B), R each independently represents NR¹R², an alkyl group, a cycloalkyl group, a heterocyclic group, an aryl group, or a heteroaryl group, each of R¹ and R² independently represents a hydrogen atom, an alkyl group, an aryl group, or, a heteroaryl group, and R¹ and R² may be bonded to form a ring structure. Provided that, in R bonded to a sulfur atom, in a case in which R is a heterocyclic group, the sulfur atom is bonded to an atom other than a nitrogen atom.

As described above, the amount of lithium resources is relatively limited, and lithium is expensive. Lithium resources are localized in South America, and for example, Japan relies entirely on imports from overseas.

In this regard, since potassium is abundantly contained in both seawater and the crust, potassium is a stable resource and can also reduce costs.

Specifically, the global production amount of lithium in 2012 is 34,970 t in terms of net content, and the production amount of potassium is 27,146 t in terms of net content.

In the case of a lithium-ion battery, since lithium forms an alloy with various metals such as aluminum, expensive copper has to be used for a current collector substrate of a negative electrode; however, potassium does not form an alloy with aluminum, and the use of inexpensive aluminum instead of copper for a negative electrode substrate is also a significant cost reduction advantage.

Since an electrolytic solution constituting a potassium-ion battery or a potassium-ion capacitor is responsible for transporting electrons between a positive electrode and a negative electrode via potassium ions, a potassium compound containing potassium as a constituent element needs to be contained.

Although the detailed mechanism of the additive according to the disclosure is unknown, it is estimated that a potassium-ion battery or potassium-ion capacitor excellent in coulombic efficiency (a value by percentage of a ratio of a discharge capacity at the time of discharging to a charge capacity at the time of charging) can be obtained since the compound represented by the Formula (1), Formula (1A), or Formula (1B) or a decomposition product thereof in the electrolytic solution forms a passive film on an electrode by having a sulfonyl fluoride structure.

It is presumed that the additive according to the disclosure can obtain excellent coulombic efficiency in the potassium-ion battery or the potassium-ion capacitor as described above, and thus can suppress loss of active potassium ions in the battery or the capacitor, and a long-life potassium-ion battery or potassium-ion capacitor can be obtained.

R in Formula (1) is preferably NR¹R², an alkyl group, an aryl group, or a heteroaryl group, more preferably NR¹R², an aralkyl group, or a heteroaryl group, still more preferably NR¹R², a benzyl group, or a 2-pyridyl group, and particularly preferably NR¹R², from the viewpoint of life in a battery or a capacitor and coulombic efficiency.

R in Formula (1A) is preferably an alkyl group, an aryl group, or heteroaryl group from the viewpoint of life in a battery or a capacitor and coulombic efficiency.

R in Formula (1B) is preferably an alkyl group, an aryl group, or heteroaryl group from the viewpoint of life in a battery or a capacitor and coulombic efficiency.

The alkyl group in R, including a substituent described below, is preferably an alkyl group having from 1 to 20 carbon atoms and more preferably an alkyl group having from 6 to 12 carbon atoms. The alkyl group in R is preferably an aralkyl group (an alkyl group substituted with an aryl group) and more preferably an aralkyl group having from 7 to 20 carbon atoms.

The aryl group in R, including a substituent described below, is preferably an aryl group having from 6 to 20 carbon atoms, more preferably an aryl group having from 6 to 12 carbon atoms, and particularly preferably a phenyl group.

The heteroaryl group in R, including a substituent described below, is preferably a heteroaryl group having from 4 to 20 carbon atoms and more preferably a heteroaryl group having from 4 to 12 carbon atoms. The heteroaryl group in R is preferably a nitrogen-containing heteroaryl group, more preferably a 5- or 6-membered nitrogen-containing heteroaryl group, and particularly preferably a pyridyl group.

Each of R¹ and R² in NR¹R² of Formula (1), Formula (1A), and Formula (1B) is independently preferably an alkyl group or an aryl group, more preferably an alkyl group, and particularly preferably a methyl group, from the viewpoint of life in a battery or a capacitor and coulombic efficiency.

As for R¹ and R² in NR¹R² of Formula (1), Formula (1A), and Formula (1B), R¹ and R² are bonded to each other to preferably form a ring structure, more preferably form a nitrogen-containing aliphatic ring structure, and particularly preferably form a 5- or 6-membered nitrogen-containing aliphatic ring structure, from the viewpoint of life in a battery or a capacitor and coulombic efficiency.

The alkyl group in R¹ and R², including a substituent described below, is preferably an alkyl group having from 1 to 8 carbon atoms, more preferably an alkyl group having from 1 to 4 carbon atoms, and particularly preferably a methyl group or an ethyl group.

The aryl group in R¹ and R², including a substituent described below, is preferably an aryl group having from 6 to 20 carbon atoms and more preferably an aryl group having from 6 to 12 carbon atoms.

The heteroaryl group in R¹ and R², including a substituent described below, is preferably a heteroaryl group having from 4 to 20 carbon atoms and more preferably a heteroaryl group having from 4 to 12 carbon atoms.

The alkyl group, the aryl group, or the heteroaryl group in R, R¹, and R² may have a substituent.

Examples of the substituent include an alkyl group, an aryl group, a heteroaryl group, a halogen atom, an alkoxy group, a dialkylamino group, a diarylamino group, an alkylarylamino group, an alkoxycarbonyl group, an acyl group, an acyloxy group, and a cyano group. The substituent may be further substituted with the substituent.

Among them, the substituent is preferably an alkyl group, an aryl group, or a heteroaryl group, and more preferably an alkyl group or an aryl group.

The compound represented by the Formula (1) is preferably a compound represented by the following Formula (2) from the viewpoint of life in a battery or a capacitor and coulombic efficiency.

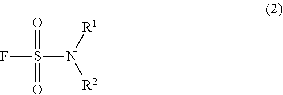

In Formula (2), each of R¹ and R² independently represents a hydrogen atom, an alkyl group, an aryl group, or, a heteroaryl group, and R¹ and R² may be bonded to form a ring structure.

Preferred aspects of R¹ and R² in Formula (2) are the same as the preferred aspects of R¹ and R² in Formula (1).

In the additive according to the disclosure, a reductive decomposition potential is preferably 0.5 V vs K/K⁺ or more and more preferably 0.8 V vs K/K⁺ or more.

The upper limit value of the reductive decomposition potential is preferably 3.0 V vs K/K⁺ from the viewpoint of stability.

The reductive decomposition potential is measured by cyclic voltammetry (CV) according to the following method. An electrolytic solution obtained by mixing 90% by mass of a 0.75 mol/kg solution of potassium hexafluorophosphate in ethylene carbonate:diethyl carbonate (volume ratio 1:1) (0.75 mol/kg KPF₆/EC:DEC) with 10% by mass of an additive is filled into a three-electrode mode cell using a graphite electrode as a working electrode, and the potential is scanned at a scanning speed of 0.5 mV/s in a base direction up to 0 V vs K/K⁺. The rising potential of the reduction current peak in the CV curve is the reductive decomposition potential.

Preferred specific examples of the compound represented by Formula (1) are shown below, but it is needless to say that the compound is not limited thereto.

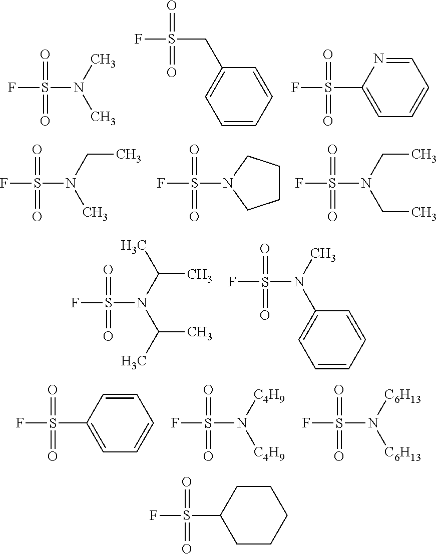

Preferred specific examples of the compound represented by Formula (1A) are shown below, but it is needless to say that the compound is not limited thereto.

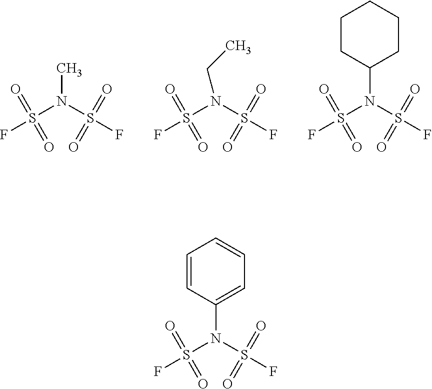

Preferred specific examples of the compound represented by Formula (1B) are shown below, but it is needless to say that the compound is not limited thereto.

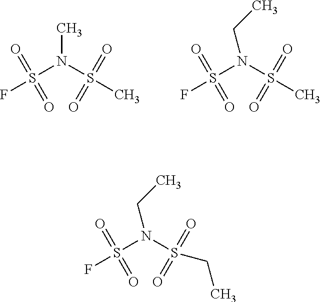

(Potassium-Ion Battery Electrolytic Solution and Potassium-Ion Capacitor Electrolytic Solution)

A potassium-ion battery or potassium-ion capacitor electrolytic solution according to the disclosure (hereinafter, also referred to as “electrolytic solution according to the disclosure”) contains the potassium-ion battery or potassium-ion capacitor electrolytic solution additive, that is, the compound represented by the Formula (1).

The electrolytic solution according to the disclosure may contain one kind of the compound represented by the Formula (1), Formula (1A), or Formula (1B) singly, or may contain two or more kinds thereof.

The content of the compound represented by the Formula (1), Formula (1A), or Formula (1B) in the electrolytic solution according to the disclosure is preferably from 0.5% by mass to 80% by mass, more preferably from 1% by mass by mass to less than 40% by mass, still more preferably from 5% by mass to less than 40% by mass, and particularly preferably from 10% by mass to 30% by mass, with respect to the total mass of the electrolytic solution, from the viewpoint of life and coulombic efficiency.

### <Solvent>

The electrolytic solution according to the disclosure preferably further contains a solvent.

Examples of the solvent include carbonic ester compounds (carbonate compounds) such as propylene carbonate, ethylene carbonate, dimethyl carbonate, diethyl carbonate, ethylmethyl carbonate, isopropylmethyl carbonate, vinylene carbonate, fluoroethylene carbonate, 4-trifluoromethyl-1,3-dioxolan-2-one, and 1,2-di(methoxycarbonyloxy) ethane;
ether compounds as such 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran;
ester compounds such as methyl formate, methyl acetate, and γ-butyrolactone;
nitrile compounds such as acetonitrile and butyronitrile;
amide compounds such as N,N-dimethylformamide and N,N-dimethylacetamide;
carbamate compounds such as 3-methyl-2-oxazolidone;
sulfur-containing compounds such as sulfolane, dimethyl sulfoxide, and 1,3-propanesultone; and compounds in which a hydrogen atom is substituted with a fluorine atom in the foregoing compounds.

In particular, the electrolytic solution according to the disclosure preferably contains at least one solvent selected from the group consisting of a carbonic ester compound and an ether compound and more preferably contains at least one solvent selected from the group consisting of ethylene glycol dimethyl ether, diethylene glycol dimethyl ether, triethylene glycol dimethyl ether, ethylene carbonate, and propylene carbonate, from the viewpoint of life in a battery or a capacitor and coulombic efficiency.

The electrolytic solution according to the disclosure more preferably contains a carbonic ester compound from the viewpoint of life in a battery or a capacitor and coulombic efficiency.

The electrolytic solution according to the disclosure may contain one kind of the solvent singly, or may contain two or more kinds thereof.

The content of the solvent contained in the electrolytic solution according to the disclosure is not particularly limited, and is preferably an amount that satisfies the content range of the additive and the concentration range of the electrolyte described below.

### <Electrolyte>

The electrolytic solution according to the disclosure preferably further contains an electrolyte.

The electrolyte used in the disclosure is not particularly limited as long as it contains a potassium salt compound as a main electrolyte.

Examples of the potassium salt compound include KClO₄, KPF₆, KNO₃, KOH, KCl, K₂SO₄, and K₂S in the case of an aqueous electrolytic solution. These potassium salts can also be used singly, or in combination of two or more kinds thereof.

In the case of a non-aqueous electrolytic solution, for example, an electrolyte (such as KPF₆, KBF₄, CF₃SO₃K, KASF₆, KB(C₆H₅)₄, CH₃SO₃K, KN(SO₂CF₃)₂, KN(SO₂C₂F₅)₂, KC(SO₂CF₃)₃, or KN(SO₃CF₃)₂) can be used as an electrolyte containing a solvent, for example, propylene carbonate (PC). Other than, a solution obtained by dissolving a potassium salt compound in a mixed solvent of ethylene carbonate (EC) and diethyl carbonate (DEC), a solution obtained by dissolving a potassium salt compound in a mixed solvent of ethylene carbonate (EC) and dimethyl carbonate (DMC), or the like can be preferably used as the electrolytic solution.

Among them, the potassium salt compound is preferably KPF₆.

The concentration of the electrolyte in the electrolytic solution is not particularly limited, and is preferably from 0.1 mol/L to 2 mol/L and more preferably from 0.5 mol/L to 1.5 mol/L.

### <Other Components>

The electrolytic solution according to the disclosure may contain other components if necessary, in addition to the additive, the solvent, and the electrolyte.

As the other components, a known additive can be used, and examples thereof include fluoroethylene carbonate (FEC), vinylene carbonate (VC), and ethylene sulfite(ES).

Examples of the other components include a solvent other than those described above, an overcharge inhibitor, a dehydrating agent, and a deoxidizing agent.

### (Potassium-Ion Battery)

A potassium-ion battery according to the disclosure is a potassium-ion battery including the potassium-ion battery electrolytic solution according to the disclosure.

The potassium-ion battery according to the disclosure can be suitably used as a potassium-ion secondary battery.

The potassium-ion battery according to the disclosure preferably includes the potassium-ion battery electrolytic solution according to the disclosure, a positive electrode, and a negative electrode, and more preferably includes the potassium-ion battery electrolytic solution according to the disclosure, a positive electrode, a negative electrode, and a separator.

The potassium-ion battery according to the disclosure preferably includes at least an aluminum member as a current collector, a case, or the like of an electrode.

In the potassium-ion battery according to the disclosure, various other known materials used in conventional lithium-ion batteries and sodium-ion batteries can also be used for elements such as structural materials other than a battery case, a spacer, a gasket, and a leaf spring, and there is no particular limitation.

The potassium-ion battery according to the disclosure may be assembled according to a known method using the battery elements. In this case, the shape of a battery is also not particularly limited, and various shapes and sizes, such as cylindrical, square, and coin shapes, can be appropriately adopted.

### <Positive Electrode>

The potassium-ion battery according to the disclosure preferably includes a positive electrode.

The positive electrode preferably contains a positive electrode active material for a potassium-ion battery. The positive electrode may other compounds in addition to the positive electrode active material for a potassium-ion battery.

The other compounds are not particularly limited, and known additives used for producing a positive electrode of a battery can be used. Specific examples thereof include a conductive aid, a binder, and a current collector.

The positive electrode preferably contains a positive electrode active material for a potassium-ion battery, a conductive aid, and a binder from the viewpoint of durability and moldability.

The shape and size of the positive electrode are not particularly limited, and can be any desired shape and size according to the shape and size of a battery to be used.

From the viewpoint of the output and charge-discharge capacity in a potassium-ion battery, the positive electrode preferably contains, with respect to the total mass of the positive electrode of a potassium-ion battery, a positive electrode active material for a potassium-ion battery preferably in an amount of 10% by mass or more, more preferably in an amount of 20% by mass or more, still more preferably in an amount of 50% by mass or more, and particularly preferably in an amount of 70% by mass or more.

### Positive Electrode Active Material for Potassium-Ion Battery

The positive electrode active material for a potassium-ion battery used in the disclosure is not particularly limited, and a known positive electrode active material for a potassium-ion battery can be used.

Specific examples of the positive electrode active material for a potassium-ion battery include a potassium salt of KₓM_{y}[Fe(CN)₆]_{z} (M=Fe, Mn, Co, Ni, Cr, or Cu, x represents a number from 0 to 2, y represents a number from 0.5 to 1.5, and z represents a number from 0.5 to 1.5), KFeSO₄F, an iron potassium phosphate compound, a vanadium potassium phosphate compound, activated carbon, α-FePO₄, K_{0.3}MnO₂, and perylene anhydride.

The shape of the positive electrode active material for a potassium-ion battery is not particularly limited as long as the shape is a desired shape, and is preferably a particulate positive electrode active material from the viewpoint of dispersibility in the case of forming a positive electrode.

In a case in which the shape of the positive electrode active material for a potassium-ion battery is particulate, an arithmetic mean particle size of the positive electrode active material for a potassium-ion battery according to the disclosure is preferably from 10 nm to 200 μm, more preferably from 50 nm to 100 μm, still more preferably from 100 nm to 80 μm, and particularly preferably from 200 nm to 50 μm, from the viewpoint of dispersibility and durability of a positive electrode.

As for a method of measuring the arithmetic mean particle size of the particles, the arithmetic mean particle size can be suitably measured, for example, by using HORIBA Laser Scattering Particle Size Distribution Analyzer LA-950 manufactured by HORIBA, Ltd. in conditions of dispersion medium: water and wavelength of laser used: 650 nm and 405 nm.

For a positive electrode described below, a positive electrode active material inside the positive electrode can be separated using a solvent or the like or physically separated and measurement can be performed.

### Conductive Aid

In the positive electrode used in the disclosure, the positive electrode active material for a potassium-ion battery may be formed into a desired shape and used as it is as a positive electrode, and in order to improve the rate performance (output) of the positive electrode, the positive electrode preferably further contains a conductive aid.

Preferable examples of the conductive aid used in the disclosure include carbons such as a carbon black, a graphite, a carbon nanotube (CNT), and a vapor growth carbon fiber (VGCF).

Examples of the carbon black include acetylene black, oil furnace carbon black, and Ketjen black. Among them, from the viewpoint of conductivity, at least one conductive aid selected from the group consisting of acetylene black and Ketjen black is preferable, and acetylene black or Ketjen black is more preferable.

The conductive aid may be used singly, or in combination of two or more kinds thereof.

The mixing ratio of the positive electrode active material and the conductive aid is not particularly limited, and the content of the conductive aid in the positive electrode is preferably from 1% by mass to 80% by mass, more preferably from 2% by mass to 60% by mass, still more preferably from 5% by mass to 50% by mass, and particularly preferably from 5% by mass to 25% by mass, with respect to the total mass of the positive electrode active material contained in the positive electrode. In a case in which the mixing ratio is in the above range, a positive electrode of higher output can be obtained, and the durability of the positive electrode is excellent.

As a method of mixing a conductive aid and a positive electrode active material, the positive electrode active material can be coated with the conductive aid by mixing the positive electrode active material with the conductive aid under an inert gas atmosphere. As the inert gas, nitrogen gas, argon gas, or the like can be used, and argon gas can be used suitably.

In the case of mixing the conductive aid and the positive electrode active material, a pulverizing and dispersing treatment may be performed using a dry ball mill, a bead mill to which a dispersion medium such as a small amount of water is added, or the like. The adhesion and dispersibility of the conductive aid and the positive electrode active material can be improved by the pulverizing and dispersing treatment, and the electrode density can be increased.

### Binder

The positive electrode used in the disclosure preferably further contains a binder from the viewpoint of moldability.

The binder is not particularly limited, a known binder can be used, examples thereof include a polymer compound, and preferable examples thereof include a fluororesin, a polyolefin resin, a rubbery polymer, a polyamide resin, a polyimide resin (such as polyamide imide), glutamic acid, and a cellulose ether.

Specific examples of the binder include polyvinylidene fluoride (PVDF), vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), polyethylene, aromatic polyamide, cellulose, styrene-butadiene rubber, isoprene rubber, butadiene rubber, ethylene-propylene rubber, styrene-butadiene-styrene block copolymer, a hydrogenated substance thereof, styrene-ethylene-butadiene-styrene copolymer, styrene-isoprene-styrene block copolymer, a hydrogenated substance thereof, syndiotactic-1,2-polybutadiene, ethylene-vinyl acetate copolymer, propylene-α-olefin (carbon number: from 2 to 12) copolymer, glutamic acid, starch, methyl cellulose, carboxymethyl cellulose, hydroxymethyl cellulose, hydroxyethyl cellulose, hydroxypropyl cellulose, carboxymethyl hydroxyethyl cellulose, nitrocellulose, polyacrylic acid, sodium polyacrylate, and polyacrylonitrile.

From the viewpoint of increasing the electrode density, the specific gravity of a compound used as the binder is preferably more than 1.2 g/cm³.

From the viewpoint of increasing the electrode density and increasing the adhesive strength, the weight average molecular weight of the binder is preferably 1,000 or more, more preferably 5,000 or more, and still more preferably 10,000 or more. The upper limit is not particularly limited, but is preferably 2,000,000 or less.

The binder may be used singly, or in combination of two or more kinds thereof.

The mixing ratio of the positive electrode active material and the binder is not particularly limited, and the content of the binder in the positive electrode is preferably from 0.5% by mass to 30% by mass, more preferably from 1% by mass to 20% by mass, and still more preferably from 2% by mass to 15% by mass, with respect to the total mass of the positive electrode active material contained in the positive electrode. In a case in which the mixing ratio is in the above range, moldability and durability are excellent.

A method of producing a positive electrode containing a positive electrode active material, a conductive aid, and a binder is not particularly limited, and for example, the producing method may be a method in which a positive electrode active material, a conductive aid, and a binder are mixed and pressure molding is performed, or a method in which a slurry described below is prepared, and a positive electrode is formed.

### Current Collector

The positive electrode used in the disclosure preferably further contains a current collector.

Examples of the current collector include a foil using a conductive material such as nickel, aluminum, or stainless steel (SUS), a mesh, an expanded grid (expanded metal), and a punched metal. The openings of the mesh, the wire diameter, the number of meshes, and the like are not particularly limited, and conventionally known ones can be used.

The shape of the current collector is not particularly limited, and may be selected in accordance with a desired shape of the positive electrode. Examples of the shape include foil-like and plate-like shapes.

Among them, an aluminum current collector is preferable as a current collector.

A method of forming a positive electrode on a current collector is not particularly limited, and examples thereof include a method of mixing a positive electrode active material, a conductive aid, a binder, and an organic solvent or water to prepare a positive electrode active material slurry and applying the positive electrode active material slurry to a current collector. Examples of the organic solvent include amine-based solvents such as N,N-dimethylaminopropylamine and diethyltriamine; ether-based solvents such as ethylene oxide and tetrahydrofuran; ketone-based solvents such as methyl ethyl ketone; ester-based solvents such as methyl acetate, and aprotic polar solvents such as dimethylacetamide and N-methyl-2-pyrrolidone.

The positive electrode is produced by, for example, applying the prepared slurry onto a current collector, and fixing the slurry by pressing after drying or the like. Examples of a method of applying the slurry onto a current collector include a slit die coating method, a screen coating method, a curtain coating method, a knife coating method, a gravure coating method, and an electrostatic spraying method.

### <Negative Electrode>

The potassium-ion battery according to the disclosure preferably includes a negative electrode.

The negative electrode used in the disclosure may be any one containing a negative electrode active material, and examples thereof include those made of a negative electrode active material, and those including a current collector and a negative electrode active material layer formed on a surface of the current collector, in which the negative electrode active material layer contains a negative electrode active material and a binder.

The current collector is not particularly limited, and the current collector described above in the positive electrode can be suitably used. Among them, an aluminum current collector is preferable.

The shape and size of the negative electrode are not particularly limited, and can be any desired shape and size according to the shape and size of a battery to be used.

Examples of the negative electrode active material include carbon materials such as natural graphite, artificial graphite, a coke, hard carbon, carbon black, a pyrolytic carbon, a carbon fiber, and sintered product of an organic polymer compound, KTi₂(PO₄)₃, P, Sn, Sb, and MXene (composite atom layer material). The shape of the carbon material may be, for example, any of flaky shape such as natural graphite, a sphere shape such as a mesocarbon microbead, a fiber shape such as graphitized carbon fiber, a particulate aggregate, or the like. The carbon material described herein may function as a conductive aid.

Among them, the negative electrode active material is preferably graphite or hard carbon and more preferably graphite.

As the negative electrode active material, potassium metal can also be suitably used.

As the negative electrode, the negative electrode described in WO 2016/059907 A can also be suitably used.

Graphite in the disclosure refers to a graphite-based carbon material.

Examples of the graphite-based carbon material include natural graphite, artificial graphite, and expanded graphite. As the natural graphite, for example, scaly graphite, massive graphite, and the like can be used. As the artificial graphite, for example, massive graphite, vapor-phase grown graphite, scaly graphite, fibrous graphite, and the like can be used. Among these, scaly graphite and massive graphite are preferable because of high packing density and the like. Two or more types of graphite may be used in combination.

The average particle diameter of the graphite is, as an upper limit value, preferably 30 μm, more preferably 15 μm, and still more preferably 10 μm, and as a lower limit value, preferably 0.5 μm, more preferably 1 μm, and still more preferably 2 μm. The average particle diameter of the graphite is a value measured by a method of electron microscope observation.

Examples of the graphite include one having an interplanar spacing d(002) of from 3.354 Å to 3.370 Å (angstrom, 1 Å=0.1 nm) and a crystallite size Lc of 150 Å or more.

The hard carbon in the disclosure is a carbon material in which the layering order hardly changes even in a case in which a heat treatment is performed at a high temperature of 2,000° C. or higher, and is also referred to as non-graphitizable carbon. Examples of the hard carbon include carbon fiber obtained by carbonizing infusible fiber, which is an intermediate product of carbon fiber producing process, at about from 1,000° C. to 1,400° C., and a carbon material carbonized at about from 1,000° C. to 1,400° C. after air oxidation of an organic compound at about 150° C. to 300° C. A method of producing a hard carbon is not particularly limited, and a hard carbon produced by a conventionally known method can be used.

The average particle diameter, the true density, the interplanar spacing of the (002) plane, and the like of the hard carbon are not particularly limited, and preferred ones can be selected and used as appropriate.

The negative electrode active material may be used singly, or in combination of two or more kinds thereof.

The content of the negative electrode active material in the negative electrode active material layer is not particularly limited, and is preferably from 80% by mass to 95% by mass.

The negative electrode according to the disclosure has a coating film (specifically, passive film) containing a reductive decomposition product of the additive according to the disclosure.

In the negative electrode according to the disclosure, decomposition of the electrolytic solution is suppressed by the coating film, and the coulombic efficiency is improved. By suppressing deterioration of the electrolytic solution, a long-life potassium-ion battery or potassium-ion capacitor can be obtained.

The coating film preferably contains an S element and an F element and more preferably contains SO₂, PF, and KF.

The constituent elements contained in the coating film and the composition thereof can be analyzed by X-ray photoelectron spectroscopy (XPS).

### <Separator>

The potassium-ion battery according to the disclosure preferably further includes a separator.

The separator physically isolates a positive electrode and a negative electrode to prevent an internal short circuit. The separator is made of a porous material, pores of which are impregnated with an electrolyte, and have ion permeability (in particular, at least potassium ion permeability) in order to ensure cell reaction.

As the separator, for example, in addition to s porous film made of a resin, a nonwoven fabric or the like can be used. The separator may be formed of only a porous film layer or a nonwoven fabric layer, or may be formed of a laminated body of a plurality of layers different in composition and form. Examples of the laminated body include a laminated body having a plurality of resin porous layers different in composition and a laminated body having a porous film layer and a nonwoven fabric layer.

The material of the separator can be selected in consideration of the operating temperature of a battery, the composition of an electrolyte, and the like.

Examples of a resin contained in a fiber forming a porous film and a nonwoven fabric include polyolefin resins such as polyethylene, polypropylene, and an ethylene-propylene copolymer; polyphenylene sulfide resins such as polyphenylene sulfide and polyphenylene sulfide ketone; polyamide resins such as an aromatic polyamide resin (an aramid resin or the like); and polyimide resins. These resins may be used singly, or in combination of two or more kinds thereof. The fiber forming the nonwoven fabric may be an inorganic fiber such as a glass fiber.

The separator is preferably a separator containing at least one material selected from the group consisting of glass, a polyolefin resin, a polyamide resin, and a polyphenylene sulfide resin. Among them, as the separator, a glass filter is more preferably exemplified.

The separator may contain an inorganic filler.

Examples of the inorganic filler include ceramics (silica, alumina, zeolite, titania, and the like), talc, mica, and wollastonite. The inorganic filler is preferably particulate or fibrous.

The content of the inorganic filler in the separator is preferably from 10% by mass to 90% by mass and more preferably from 20% by mass to 80% by mass.

The shape and size of the separator are not particularly limited, and may be appropriately selected in accordance with a desired battery shape and the like.

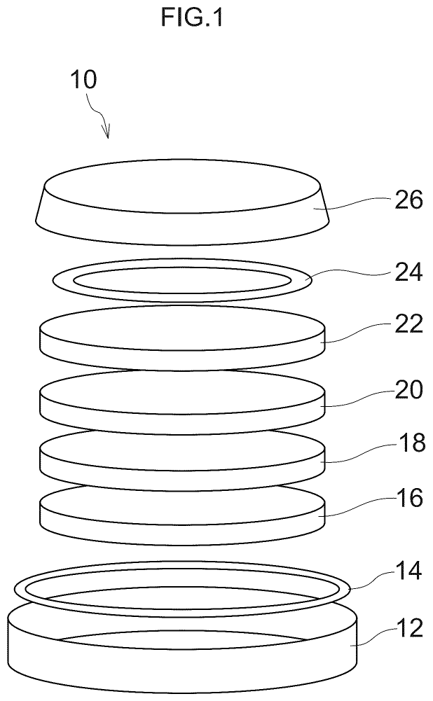

Although the potassium-ion battery illustrated in FIG. 1 is exemplified as an example of the potassium-ion battery according to the disclosure, it is needless to say that the disclosure is not limited thereto.

FIG. 1 is a schematic view illustrating an example of a potassium-ion battery 10 according to the disclosure.

The potassium-ion battery 10 illustrated in FIG. 1 is a coin type battery, and is formed by overlapping a battery case 12 on the negative electrode side, a gasket 14, a negative electrode 16, a separator 18, a positive electrode 20, a spacer 22, a leaf spring 24, and a battery case 26 on the positive electrode side sequentially from the negative electrode side, and fitting the battery case 12 and the battery case 26 together.

The separator 18 is impregnated with the electrolytic solution according to the disclosure (not illustrated).

### (Potassium-Ion Capacitor)

The potassium-ion capacitor according to the disclosure includes the potassium-ion capacitor electrolytic solution according to the disclosure.

The potassium-ion capacitor according to the disclosure can be basically produced, for example, in the same configuration as that of a conventional lithium-ion capacitor, except that the potassium-ion capacitor electrolytic solution according to the disclosure is used as an electrolytic solution and potassium ions are used instead of lithium ions.

The potassium-ion capacitor electrolytic solution according to the disclosure contains the additive according to the disclosure, and a preferred embodiment of the potassium-ion capacitor electrolytic solution according to the disclosure is the same as the preferred embodiment of the potassium-ion battery electrolytic solution according to the disclosure.

In the potassium-ion battery, each constituent members described above can also be suitably used for the potassium-ion capacitor according to the disclosure.

### EXAMPLES

Hereinafter, the invention will be described more specifically with reference to Examples. Materials, amounts used, proportions, treatment details, treatment procedures, and the like shown in the following Examples can be appropriately changed without departing from the gist of the invention. Therefore, the scope of the invention is not limited to the following specific examples.

### Example 1 and Comparative Example 1

Each electrolytic solution was prepared by mixing the potassium salt compound, a solvent, and an additive shown below so as to have the following composition.

Example 1: a solution obtained by mixing 90% by mass of a 0.75 mol/kg solution of potassium hexafluorophosphate in ethylene carbonate:diethyl carbonate (volume ratio 1:1) (0.75 mol/kg KPF₆/EC:DEC) with 10% by mass of dimethylsulfamoyl fluoride (DMSF)

Comparative Example 1: a 0.75 mol/kg solution of potassium hexafluorophosphate in ethylene carbonate:diethyl carbonate (volume ratio 1:1) (0.75 mol/kg KPF₆/EC:DEC) Details of the compounds used are shown below.

Potassium hexafluorophosphate (KPF₆): manufactured by KISHIDA CHEMICAL CO., LTD.

Ethylene carbonate (EC): manufactured by KISHIDA CHEMICAL CO., LTD.

Diethyl carbonate (DEC): manufactured by KISHIDA CHEMICAL CO., LTD.

Dimethylsulfamoyl fluoride (DMSF): the following compound, manufactured by Enamine Ltd.

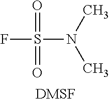

### <Production of Graphite Electrode>

To water as a viscosity-adjusting solvent, 10 parts by mass of polyacrylic acid sodium salt (PANa, manufactured by KISHIDA CHEMICAL CO., LTD., molecular weight of from 2,000,000 to 6,000,000) as a binder was added, 90 parts by mass of graphite (manufactured by SEC CARBON, LIMITED, SNO3, particle diameter: about 3 μm) as a negative electrode active material was further added thereto, and the mixture was mixed and stirred in a mortar to obtain a negative electrode mixture slurry.

The obtained negative electrode mixture slurry was applied onto an aluminum foil as a negative electrode current collector, and dried in a vacuum dryer at 150° C. to obtain an electrode sheet. The electrode sheet was punched into a circle having a diameter of 10 mm with an electrode punching machine, and the punched electrode was used as a graphite electrode. The mass of the positive electrode containing no aluminum foil was from 1.5 mg to 2 mg.

### <Measurement of Charging and Discharging in Case of Using Graphite Electrode>

Measurement of charging and discharging was performed in a coin cell produced using the following electrolytic solution as an electrolytic solution, the graphite electrode produced above as a working electrode, potassium metal (manufactured by Aldrich) as a counter electrode, a separator (glass filter, manufactured by ADVANTEC CO., LTD.), an SUS battery case and a polypropylene gasket (CR2032 manufactured by Hohsen Corp.), a spacer (material: SUS, diameter 16 mm× height 0.5 mm, manufactured by Hohsen Corp.), and a leaf spring (material: SUS, inner diameter: 10 mm, height: 2.0 mm, thickness: 0.25 mm, WASHER manufactured by Hohsen Corp.).

The amount of the electrolyte solution used was such that the electrolytic solution was sufficiently filled into the separator (from 0.15 mL to 0.3 mL).

In Example 1, a 0.75 mol/kg KPF₆/EC:DEC+10% by mass DMSF solution was used as the electrolytic solution, and in Comparative Example 1, a 0.75 mol/kg KPF₆/EC:DEC solution was used as the electrolytic solution.

The measurement was performed at 25° C. under charging and discharging conditions in which the charge current density was set to a constant current mode, and the discharge current density was set to a constant current-constant voltage mode. The current density was set to 25 mA/g, and constant current discharging was performed to a discharging voltage of 0.002 V. After discharging, constant current charging was performed until the charging end voltage was 2.0 V, and charging and discharging were repeated.

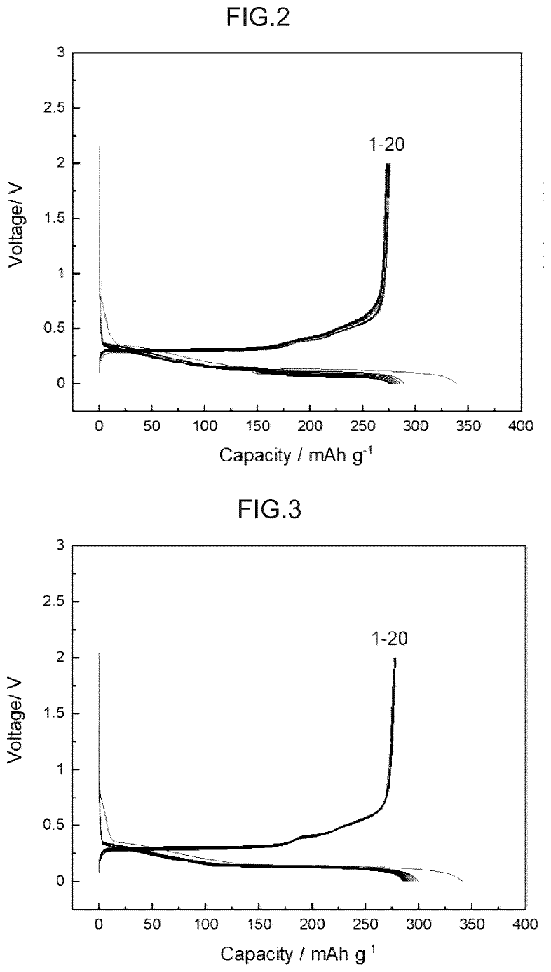

FIG. 2 shows a charge-discharge curve up to 20th cycle in Example 1.

FIG. 3 shows a charge-discharge curve up to 20th cycle in Comparative Example 1.

In FIGS. 2 and 3, the vertical axis represents a voltage (unit: V) and a discharge capacity (unit: mAh/g).

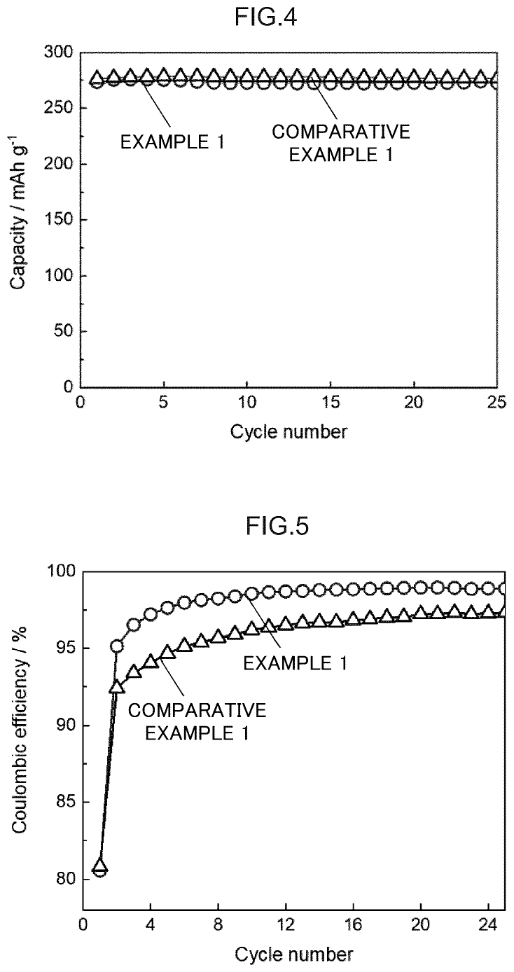

FIG. 4 shows a view of a change in discharge capacity in Example 1 and Comparative Example 1.

In FIG. 4, the vertical axis represents a discharge capacity (unit: mAh/g) and the horizontal axis represents the number of cycles.

FIG. 5 shows a view of a change in coulombic efficiency in Example 1 and Comparative Example 1.

In FIG. 5, the vertical axis represents coulombic efficiency and the horizontal axis represents the number of cycles.

In the measurement under the conditions described above, no large difference was observed in the charge-discharge curve and the discharge capacity in Example 1 and Comparative Example 1 up to the 20th cycle, but Example 1 was superior to Comparative Example 1 in coulombic efficiency.

### Example 2 and Comparative Example 2

### <Production of Positive Electrode>

A positive electrode was produced by pressure-bonding a mixture of K₂Mn[Fe(CN)₆], Ketjen black (KB, manufactured by Lion Specialty Chemicals Co., Ltd.), and PTFE (polytetrafluoroethylene resin, manufactured by DAIKIN INDUSTRIES, LTD.) at a mass ratio of 70:20:10 onto an aluminum mesh. The shape of a positive electrode containing no aluminum mesh was a cylindrical shape having a diameter of 10 mm and a thickness of from 0.03 mm to 0.04 mm. The mass of the positive electrode containing no aluminum mesh was from 3 mg to 4 mg.

### <Measurement of Charging and Discharging>

Measurement of charging and discharging was performed in a coin cell produced using the following electrolytic solution as an electrolytic solution, K₂Mn [Fe(CN)₆] electrode produced above as a positive electrode, the graphite electrode produced above as a negative electrode, a separator (glass filter, manufactured by Hohsen Corp.), an SUS-Al clad battery case and a polypropylene gasket (CR2032 manufactured by Hohsen Corp.), a spacer (material: SUS, diameter 16 mm×height 0.5 mm, manufactured by Hohsen Corp.), and a leaf spring (material: SUS, inner diameter: 10 mm, height: 2.0 mm, thickness: 0.25 mm, WASHER manufactured by Hohsen Corp.). The ratio of the active material weights of the positive electrode and the negative electrode (positive electrode/negative electrode) was from 2.0 to 2.1.

The amount of the electrolyte solution used was such that the electrolytic solution was sufficiently filled into the separator (from 0.15 mL to 0.3 mL).

In Example 2, a 0.75 mol/kg KPF₆/EC:DEC+10% by mass DMSF solution was used as the electrolytic solution, and in Comparative Example 2, a 0.75 mol/kg KPF₆/EC:DEC solution was used as the electrolytic solution.

The measurement was performed at 25° C. under charging and discharging conditions in which the charge-discharge current density was set to a constant current mode. The constant current charging was performed until the charging voltage reached 4.3 V while the current density was set to 15.5 mA/g (0.1 C) per weight of the positive electrode active material from the first cycle to the fifth cycle of charging and discharging and was set to 155 mA/g (1 C) per weight of the positive electrode active material from the sixth cycle to 500th cycle of charging and discharging. After charging, constant current discharging was performed until the discharging end voltage was 1.5 V, and charging and discharging were repeated.

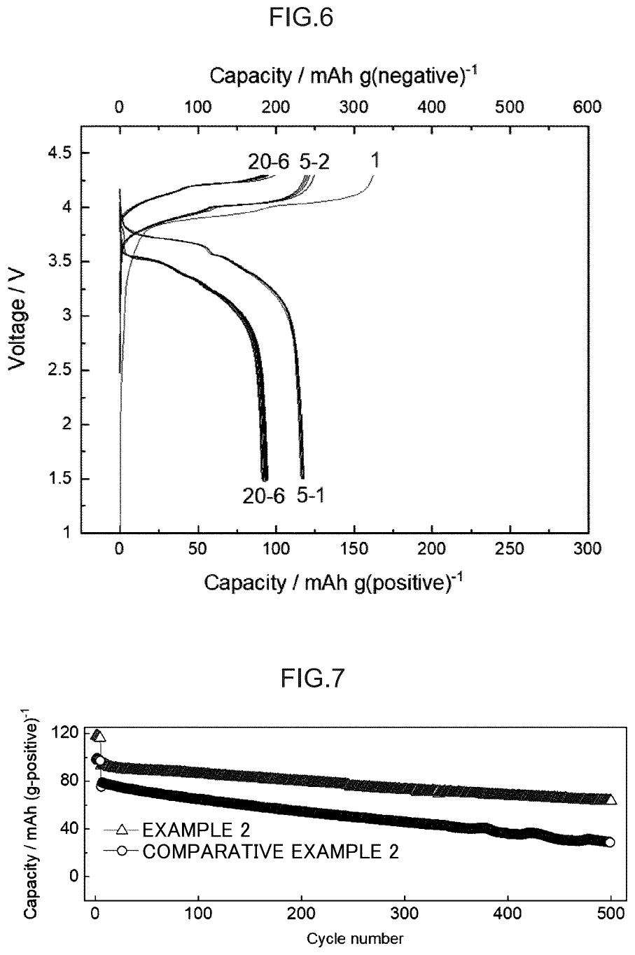

FIG. 6 shows a charge-discharge curve up to 20th cycle in Example 2.

In FIG. 6, the vertical axis represents a voltage (unit: V) and a discharge capacity (unit: mAh/g (positive electrode active material or negative electrode active material)).

FIG. 7 shows a view of a change in discharge capacity in Example 2 and Comparative Example 2.

In FIG. 7, the vertical axis represents a discharge capacity (unit: mAh/g (positive electrode active material)) and the horizontal axis represents the number of cycles (Cycle Number).

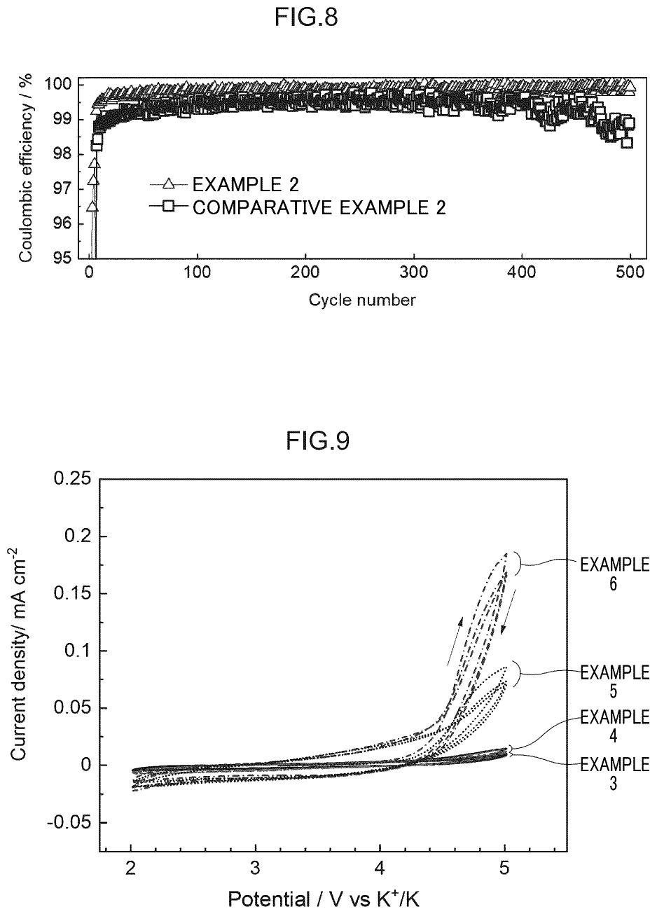

FIG. 8 shows a view of a change in coulombic efficiency in Example 2 and Comparative Example 2.

In FIG. 8, the vertical axis represents coulombic efficiency and the horizontal axis represents the number of cycles.

In the measurement under the conditions described above, Example 2 was superior to Comparative Example 2 in discharge capacity and coulombic efficiency.

### Examples 3 to 6

### <Evaluation of Oxidation Resistance of Electrolytic Solution>

### Cyclic Voltammetry (CV) Measurement

The cyclic voltammetry (CV) measurement was performed using each electrolytic solution obtained by mixing a 0.75 mol/kg solution of potassium hexafluorophosphate in ethylene carbonate: diethyl carbonate (volume ratio 1:1) (0.75 mol/kg KPF₆/EC:DEC) with 10% by mass (Example 3), 30% by mass (Example 4), 40% by mass (Example 5), or 50% by mass (Example 6) of dimethylsulfamoyl fluoride (DMSF).

Using each of the obtained electrolytic solutions, CV measurement was performed at a scan rate of 0.5 mV/s and at a sweep range of voltage of from 2.0 V to 5.0 V for 3 cycles using an aluminum foil as a working electrode, an electrode produced by pressure-bonding a mixture of activated carbon, Ketjen black, and PTFE at a mass ratio of 80:10:10 onto an aluminum mesh as a counter electrode, and an Ag/Ag⁺ electrode as a reference electrode.

FIG. 9 shows cyclic voltammetry (CV) curves in the case of using electrolytic solutions of Examples 3 to 6.

In FIG. 9, the vertical axis represents a current density (unit: mAh/cm²) and the horizontal axis represents a potential (unit: V (V vs. K/K⁺)) based on the standard single electrode potential of potassium metal.

In the CV measurement, since oxidation current is generated along with the oxidative decomposition of the electrolytic solution, the oxidation resistance of the electrolytic solution is more excellent as the current density to be measured is smaller. As shown in FIG. 9, the electrolytic solutions in Examples 3 to 5 are superior to the electrolytic solution in Example 6 in oxidation resistance, and the electrolytic solution in Example 3 or 4 is superior to the electrolytic solution in Example 5 or 6 in oxidation resistance.

### Examples 100 and 101

Each electrolytic solution was prepared by mixing the potassium salt compound, a solvent, and an additive shown below so as to have the following composition.

Example 100: a solution obtained by mixing 90% by mass of a 0.75 mol/kg solution of potassium hexafluorophosphate in ethylene carbonate: diethyl carbonate (volume ratio 1:1) (0.75 mol/kg KPF₆/EC:DEC) with 1% by mass of dimethylsulfamoyl fluoride (DMSF)

Example 101: a solution obtained by mixing 90% by mass of a 0.75 mol/kg solution of potassium hexafluorophosphate in ethylene carbonate: diethyl carbonate (volume ratio 1:1) (0.75 mol/kg KPF₆/EC:DEC) with 1% by mass of diethylsulfamoyl fluoride (DESF)

Details of the compounds used are shown below.

Diethylsulfamoyl fluoride (DESF): the following compound, manufactured by Enamine Ltd.

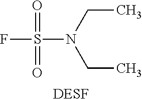

The coulombic efficiency in Examples 100 and 101 and Comparative Example 1 was measured by the same method as in “Measurement of Charging and Discharging in Case of Using Graphite Electrode” described above.

The coulombic efficiency in Comparative Example 1 was 93.3%, whereas the coulombic efficiency in Example 100 was 95.5% and the coulombic efficiency in Example 101 was 95.2%.

From the above, it was found that the coulombic efficiency was excellent in the case of using DESF as in the case of using DMSF.

<Calculation of Reductive Decomposition Potential by Density Functional Theory (DFT)>

The reductive decomposition potentials of the compounds, EC, and DEC shown below were calculated by Gaussian 09 program. The calculation was performed at the B3LYP-6-31+G (d,p) level and the solvent effect of acetonitrile (relative permittivity ¿=36.64) according to the polarizable continuum (IEFPCM) model was used. The calculated values are as follows.

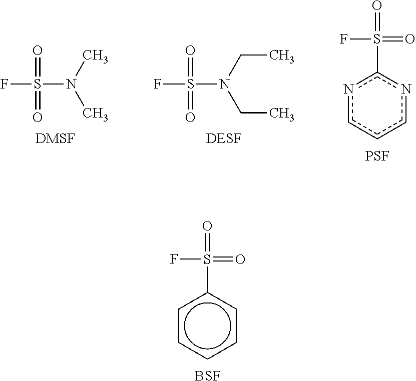

### Calculated Value of Reductive Decomposition Potential

DMSF: −0.84774 V
DESF:−0.89957 V
PSF:−0.74147 V
BSF:−0.87849 V
EC:−2.96915 V
DEC:−3.21639 V

DMSF, DESF, PSF, and BSF were found to have higher reductive decomposition potentials than EC and DEC. The calculated value of the reductive decomposition potential does not necessarily coincide with the measured value of the reductive decomposition potential, but the relative relationship is the same. Therefore, also in the measured value of the reductive decomposition potential, DMSF, DESF, PSF, and BSF have higher reductive decomposition potentials than EC and DEC. Therefore, even in a case in which PSF or BSF is used as the additive, it is considered that the coulombic efficiency is excellent as in the case of using DMSF and DESF as the additive.

### <Surface Analysis of Negative Electrode>

After 10 cycles of constant current charging and discharging of the graphite electrode were performed by the same method as in “Measurement of Charging and Discharging in Case of Using Graphite Electrode” described above, the coin cell was disassembled, and the graphite electrode was taken out and washed with a DEC solvent to prepare samples. These samples were subjected to XPS measurement using an X-ray photoelectron spectrometer (JPS 9010MC, manufactured by JEOL Ltd.).

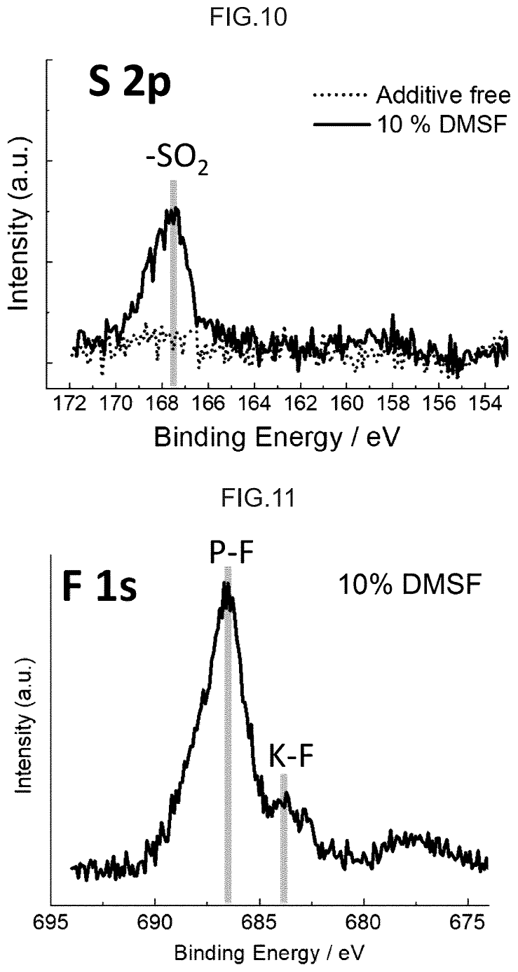

FIG. 10 shows surface analysis results of a negative electrode in Example 1 and Comparative Example 1.

FIG. 11 shows surface analysis results of a negative electrode in Example 1.

In FIGS. 10 and 11, the vertical axis represents intensity and the horizontal axis represents binding energy (unit: eV).

In the surface analysis of the negative electrode, it was found that a coating film was formed on the surface of the negative electrode, and the coating film contained SO₂, PF, and KF. In Example 1, since such a coating film is formed, it is considered that decomposition of the electrolytic solution is suppressed and the coulombic efficiency is improved. Example 1 shows the case of using DMSF (the compound represented by Formula (1)) as the additive, but the same applies to the case of using the other additives other than DMSF.

The entire contents of the disclosures by Japanese Patent Application No. 2021-173969 filed on Oct. 25, 2021 are incorporated herein by reference. All the literature, patent application, and technical standards cited herein are also herein incorporated to the same extent as provided for specifically and severally with respect to an individual literature, patent application, and technical standard to the effect that the same should be so incorporated by reference.

1. A potassium-ion battery electrolytic solution additive, which is a compound represented by the following Formula (1), Formula (1A), or Formula (1B): 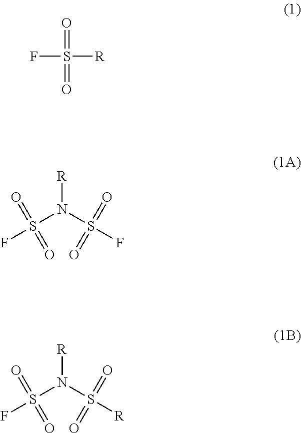
wherein, in Formula (1), Formula (1A), and Formula (1B), each R independently represents NR¹R², an alkyl group, a cycloalkyl group, a heterocyclic group, an aryl group, or a heteroaryl group, each of R¹ and R² independently represents a hydrogen atom, an alkyl group, an aryl group, or a heteroaryl group, and R¹ and R² may be bonded to form a ring structure, provided that, in R bonded to a sulfur atom, in a case in which R is a heterocyclic group, the sulfur atom is bonded to an atom other than a nitrogen atom.

2. The potassium-ion battery electrolytic solution additive according to claim 1, wherein the compound represented by the Formula (1) is a compound represented by the following Formula (2): 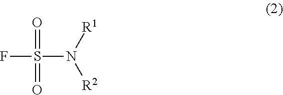
wherein, in Formula (2), each of R¹ and R² independently represents a hydrogen atom, an alkyl group, an aryl group, or, a heteroaryl group, and R¹ and R² may be bonded to form a ring structure.

3. The potassium-ion battery electrolytic solution additive according to claim 2, wherein each of R¹ and R² independently represents an alkyl group.

4. The potassium-ion battery electrolytic solution additive according to claim 1, wherein a reductive decomposition potential is 0.5 V vs K/K⁺ or more.

5. A potassium-ion battery electrolytic solution comprising the potassium-ion battery electrolytic solution additive according to claim 1.

6. The potassium-ion battery electrolytic solution according to claim 5, wherein a content of the potassium-ion battery electrolytic solution additive is from 1% by mass to less than 40% by mass with respect to a total mass of the potassium-ion battery electrolytic solution.

7. The potassium-ion battery electrolytic solution according to claim 5, further comprising a solvent.

8. The potassium-ion battery electrolytic solution according to claim 7, wherein the solvent includes at least one solvent selected from the group consisting of a carbonic ester compound and an ether compound.

9. A potassium-ion battery comprising the potassium-ion battery electrolytic solution according to claim 5.

10. A potassium-ion capacitor electrolytic solution additive, which is a compound represented by the following Formula (1), Formula (1A), or Formula (1B): 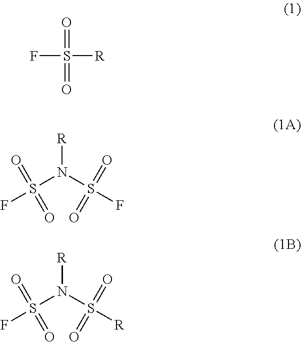
wherein, in Formula (1), Formula (1A), and Formula (1B), each R independently represents NR′R², an alkyl group, a cycloalkyl group, a heterocyclic group, an aryl group, or a heteroaryl group, each of R¹ and R² independently represents a hydrogen atom, an alkyl group, an aryl group, or, a heteroaryl group, and R¹ and R² may be bonded to form a ring structure, provided that, in R bonded to a sulfur atom, in a case in which R is a heterocyclic group, the sulfur atom is bonded to an atom other than a nitrogen atom.

11. The potassium-ion capacitor electrolytic solution additive according to claim 10, wherein the compound represented by the Formula (1) is a compound represented by the following Formula (2): 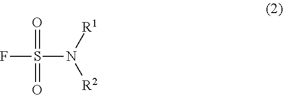
wherein, in Formula (2), each of R¹ and R² independently represents a hydrogen atom, an alkyl group, an aryl group, or a heteroaryl group, and R¹ and R² may be bonded to form a ring structure.

12. The potassium-ion capacitor electrolytic solution additive according to claim 11, wherein each of R¹ and R² independently represents an alkyl group.

13. The potassium-ion capacitor electrolytic solution additive according to claim 10, wherein a reductive decomposition potential is 0.5 V vs K/K⁺ or more.

14. A potassium-ion capacitor electrolytic solution comprising the potassium-ion capacitor electrolytic solution additive according to claim 10.

15. The potassium-ion capacitor electrolytic solution according to claim 14, wherein a content of the potassium-ion capacitor electrolytic solution additive is from 1% by mass to less than 40% by mass with respect to a total mass of the potassium-ion capacitor electrolytic solution.

16. The potassium-ion capacitor electrolytic solution according to claim 14, further comprising a solvent.

17. The potassium-ion capacitor electrolytic solution according to claim 16, wherein the solvent includes at least one solvent selected from the group consisting of a carbonic ester compound and an ether compound.

18. A potassium-ion capacitor comprising the potassium-ion capacitor electrolytic solution according to claim 14.

19. A negative electrode comprising, on a surface thereof, a coating film containing a reductive decomposition product of the potassium-ion battery electrolytic solution additive according to claim 1.

20. A negative electrode comprising, on a surface thereof, a coating film containing a reductive decomposition product of the potassium-ion capacitor electrolytic solution additive according to claim 10.

21. The negative electrode according to claim 19, wherein the coating film contains an S element and an F element.

22. The negative electrode according to claim 19, wherein the coating film contains SO₂, PF, and KF.

23. The negative electrode according to claim 20, wherein the coating film contains an S element and an F element.

24. The negative electrode according to claim 20, wherein the coating film contains SO₂, PF, and KF.
